(19) United States
(12) Patent Application Publication
(10) Pub. No.: US 2005/0287995 A1
(43) Pub. Date: Dec. 29, 2005

(54) Method and apparatus for performing communication function while performing multimedia function

(75) Inventor: Sang-Hyeon Yoon, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/159,765

(22) Filed: Jun. 23, 2005

(30) Foreign Application Priority Data
Jun. 24, 2004 (KR) 47703/2004

(51) Int. Cl. H04M 1/00

(52) U.S. Cl. 455/414.1; 455/550.1

(57) ABSTRACT

Disclosed are a method and an apparatus for performing a communication function while performing a multimedia function. The apparatus having a speaker unit, a microphone unit, a key input unit, and a display unit, includes a first control unit for controlling the communication function of the apparatus in possession of a control authority over the apparatus, and a second control unit for controlling the multimedia function of the apparatus by receiving the control authority over the apparatus from the first control unit when the multimedia function is performed, wherein, in a concurrent service mode where both the multimedia function and the multimedia function are concurrently performed when the communication function is requested in process of performing the multimedia function, the second control unit delivers only a sound control authority over the apparatus to the first control unit and blocks output of multimedia audio data of the speaker unit, and the first control unit receives the sound control authority so as to control input/output of phone sound in the microphone unit and the speaker unit.

### PRIORITY

This application claims priority to an application entitled “Method and Apparatus for Performing Communication Function While Performing Multimedia Function” filed in the Korean Intellectual Property Office on Jun. 24, 2004 and assigned Ser. No. 2004-47703, the contents of which are incorporated herein by reference.

### BACKGROUND OF THE INVENTION

1. Field of the Invention

The present invention relates to an apparatus for performing both a multimedia function and a communication function, and more particularly to an apparatus and a method for performing a communication function in the course of performing a multimedia function.

2. Description of the Related Art

Recently, the growth of communication techniques is inducing the development of mobile communication terminals with multimedia functions (e.g., a camera function, a video function, a digital broadcasting service function, etc) and the development of multimedia devices with mobile communication functions. Camera phones, VOD (video on demand) phones, and DMB (digital multimedia broadcasting) phones are examples of such apparatuses. In particular, the DMB phones are designed to receive digital broadcasting through the mobile communication terminals and are attracting more and more attention because users can listen to digital broadcasting while on the move.

However, the apparatuses cannot perform multimedia functions and communication functions at the same time. For example, to carry out voice communication in the course of using multimedia functions, the apparatuses must stop performing the multimedia functions. After the voice communication, the apparatuses are unable to automatically perform mode transition into the previous multimedia mode.

FIG. 1 is a flowchart for illustrating a procedure of transferring a control authority for performing a multimedia function in a conventional apparatus having a communication function and a multimedia function. In particular, FIG. 1 illustrates a procedure of transferring a terminal control authority (e.g., voice input/output control, multimedia data input/output control, etc.) when a mobile communication terminal (including a communication function control unit for controlling a communication function and a multimedia function control unit for controlling a multimedia function) performs the multimedia function.

In a typical mobile communication terminal, a corresponding terminal control authority usually belongs to the communication function control unit 31. Accordingly, when a multimedia function is requested (step S11), the communication function control unit 31 delivers the terminal control authority to the multimedia function control unit 33 (step S13). In this case, the communication function control unit 31 does not perform any functions for controlling the operation of the terminal except for generating an event corresponding to an operation signal input through a user interface and delivering the event to the multimedia function control unit 33.

Accordingly, after step S13, the communication function control unit 31 detects the input of the operation signal and generates an event corresponding to the operation signal (step S17) so as to deliver the event to the multimedia function control unit 33 (step S19). The multimedia function control unit 33 performs a multimedia function (step S21) by using the terminal control authority delivered through step S13. After that, if the event for termination of the multimedia function through step S19 has been reached (step S23), the multimedia function control unit 33 terminates the multimedia function (step S25) and transfers the terminal control authority to the communication function control unit 31 (step S27). If an event having been delivered through step S19 is not the event for terminating the multimedia function, the multimedia function control unit 33 continuously performs the multimedia function (step S21).

As described above, conventionally, the communication function control unit 31 or the multimedia function control unit 33 controls the terminal with a corresponding terminal control authority according to an operation mode of the terminal. In other words, the communication function control unit 31 and the multimedia function control unit 33 do not have the terminal control authority at the same time. Accordingly, the conventional apparatus having a communication function and a multimedia function cannot perform the two functions at the same time when communication is requested in the course of performing a multimedia function.

For example, when the terminal receives a communication request signal in the course of performing a multimedia function, and when a user selects a communication mode, the communication function control unit 31 generates an event for the notification of this in step S17. In other words, the communication function control unit 31 generates an event for notifying that an operation mode of the terminal must be switched into the communication mode (step S17). Then, the communication function control unit 31 transfers the event to the multimedia function control unit 33 (step S19). Then, the multimedia function control unit 33 terminates the multimedia function (step S25) and then transfers the terminal control authority to the communication function control unit 31 (step S27) in response to the event.

FIG. 2 is a flowchart illustrating a procedure of performing a communication function in the course of performing a multimedia function in the conventional apparatus having the communication function and the multimedia function. In other words, FIG. 1 illustrates a procedure of performing a communication function in the course of performing a multimedia function in an apparatus transferring the control authority.

Referring to FIG. 2, if a communication function is requested (step S33) while an apparatus having a communication function and a multimedia function (e.g., a mobile communication terminal with a multimedia function or a multimedia terminal with a communication function; a hybrid terminal) is operating in a multimedia mode (step S31), the hybrid terminal terminates the multimedia mode (step S35) and performs the communication function through mode transition into a communication mode (step S37). The communication mode is maintained until the communication function is terminated (step S39).

For example, if a communication request is received while a user is using digital broadcasting services through the hybrid terminal (i.e. in the course of viewing the digital broadcasting services), the user must stop viewing the digital broadcasting services to carry out voice communication in response to the communication request in the conventional technique. In addition, after the voice communication of the user, the interrupted digital broadcasting services cannot be automatically resumed.

Accordingly, conventionally, the user employing the hybrid terminal cannot conveniently perform a multimedia function and a communication function.

### SUMMARY OF THE INVENTION

Accordingly, the present invention has been made to solve the above-mentioned problems occurring in the prior art, and the present invention provides an apparatus and a method which enable a hybrid terminal to concurrently perform both communication functions (e.g., voice communication and letter communication) and multimedia functions.

In addition, the present invention provides an apparatus and a method for enhancing the quality of multimedia functions (a camera function, a video function, a digital broadcast function, etc.) by using a hybrid terminal.

Further, the present invention provides an apparatus and a method for enabling digital broadcasting service users employing hybrid terminals to conveniently view digital broadcasting and use communication functions.

According to a preferred embodiment of the present invention, there is provided an apparatus for performing a communication function and a multimedia function, the apparatus including a speaker unit, a microphone unit, a key input unit, and a display unit, the apparatus including a first control unit for controlling the communication function of the apparatus in possession of a control authority over the apparatus, and a second control unit for controlling the multimedia function of the apparatus by receiving the control authority over the apparatus from the first control unit when the multimedia function is performed, wherein, in a concurrent service mode where both the multimedia function and the multimedia function are concurrently performed when the communication function is requested in process of performing the multimedia function, the second control unit delivers only a sound control authority over the apparatus to the first control unit and blocks output of multimedia audio data of the speaker unit, and the first control unit receives the sound control authority so as to control input/output of phone sound in the microphone unit and the speaker unit.

According to a preferred embodiment of the present invention, there is provided a method for performing a communication function in process of performing a multimedia communication by an apparatus including a first control unit and a second control unit, the first control unit controlling the communication function of the apparatus in possession of a control authority over the apparatus, the second control unit controlling the multimedia function of the apparatus by receiving the control authority over the apparatus from the first control unit when the multimedia function is performed, the method including the steps of blocking output of multimedia audio data delivering only sound control authority over the apparatus to the first control unit by the second control unit when the communication function is requested in the process of performing the multimedia function of the apparatus, controlling by the first control unit transmit/receive of phone sound using the sound control authority to concurrently perform the communication function and the multimedia function, delivering by the first control unit the sound control authority to the second control unit when the communication function is terminated, and re-obtaining by the second control unit the sound control authority.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart for illustrating a procedure of transferring a control authority for performing a multimedia function in the conventional apparatus having a communication function and a multimedia function;

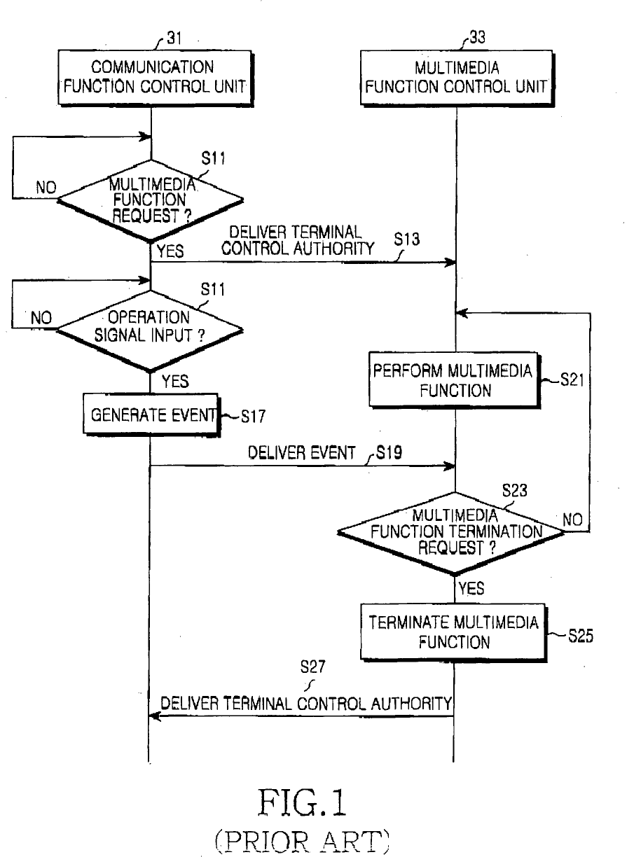

FIG. 2 is a flowchart illustrating a procedure of performing a communication function in the course of performing a multimedia function in the conventional apparatus having the communication function and the multimedia function;

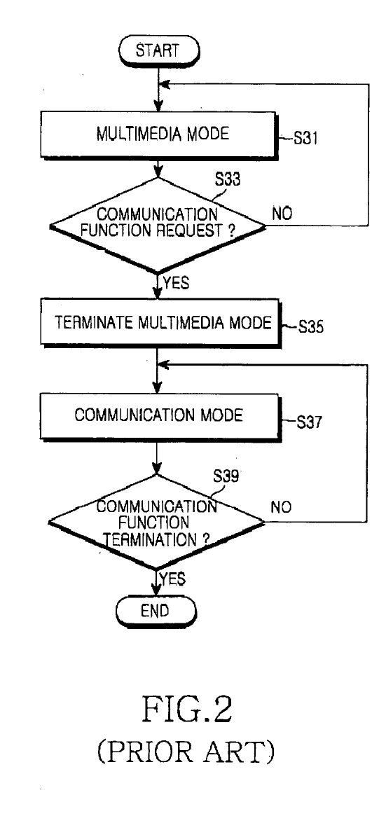

FIG. 3 is a block diagram illustrating a structure of a mobile communication terminal according to an embodiment of the present invention that performs a communication function in the course of performing a multimedia function;

FIG. 4 is a flowchart illustrating a procedure for transferring a control authority for performing a communication function in the course of performing a multimedia function in an apparatus having a communication function and a multimedia function according to an embodiment of the present invention;

FIG. 5 is a flowchart illustrating a procedure of performing a communication function in the course of performing a multimedia function in an apparatus having a communication function and a multimedia function according to an embodiment of the present invention; and

FIG. 6 illustrates a window for displaying or inputting a phone number in a concurrent service mode according to an embodiment of the present invention.

### DETAILED DESCRIPTION OF THE PREFERRED EMBODIMENT

Hereinafter, a preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

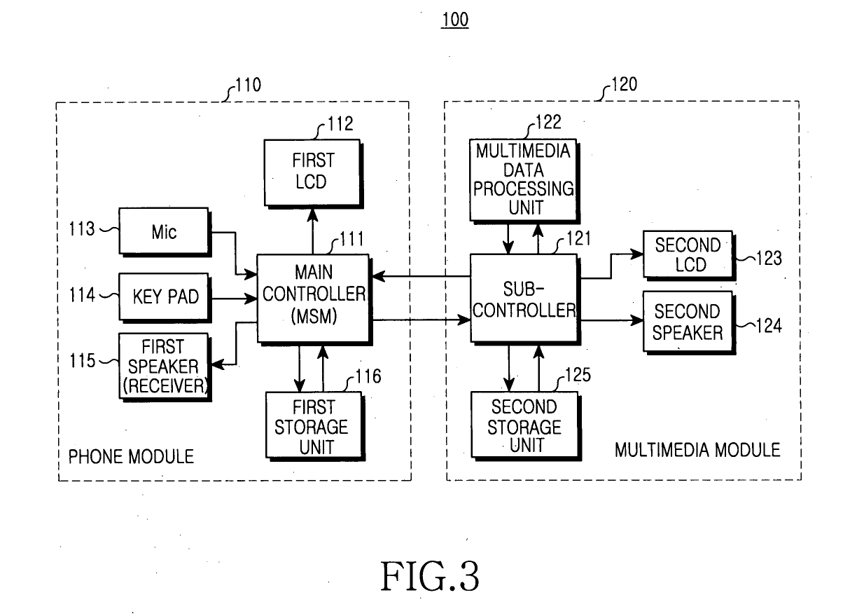

FIG. 3 is a block diagram illustrating the structure of a mobile communication terminal 100 (an apparatus having the communication function and the multimedia function) that performs a communication function in the course of performing a multimedia function according to an embodiment of the present invention. The mobile communication terminal 100 includes a portable phone function module (called a phone-module) 110 for controlling a portable phone function and a multimedia module 120 for controlling a multimedia function (e.g., a camera function, a video function, and a broadcasting receiving function).

The phone-module 110 includes a main controller 111 for controlling the overall function of the mobile communication terminal having the portable phone function (herein, the controller 111 is realized using a mobile station modem (MSM) chip shown in FIG. 3 and is referred to as MSM), a first display unit (such as an LCD) 112 for displaying information regarding the overall function of the mobile communication terminal having the portable phone function, a microphone 113 for inputting an audio signal, a key pad 114 used for inputting a control command to the MSM 111, a first speaker 115 used for outputting an audio signal relating to the portable phone function, and a first storage unit 116 for storing information regarding the overall function of the mobile communication terminal having the portable phone function. Herein, the first speaker 115 operates as a receiver.

The multimedia module 120 includes a multimedia data processing unit 122 for processing multimedia data (e.g., video data and broadcasting data), a sub-controller 121 for outputting multimedia data as information provided to the user by decoding the multimedia data, a second LCD 123 for displaying video information output from the sub-controller 121, a second speaker 124 for outputting an audio signal output from the sub-controller 121, and a second storage unit 125 for storing information regarding the multimedia function.

Herein, the multimedia data processing unit 122 processes video data collected from a camera when the mobile communication terminal 100 is a camera phone. In addition, the multimedia data processing unit 122 processes broadcasting data when the mobile communication terminal 100 is a DMB phone.

The second speaker 124 for outputting sound information included in multimedia data has a stereo function, and the second LCD 123 outputs image information included in the multimedia data. In the meantime, the second speaker 124 and the second LCD 123 include an output interface unit for outputting the multimedia data. The output interface unit may include one of a speaker and an LCD according to types of multimedia data. For example, the output interface unit includes only a speaker in a case of digital audio broadcast or only an LCD in a case of video collected by the camera.

In addition, the first speaker 115, the second speaker 124, the first LCD 112, and the second LCD 123 may be constructed either as separate hardware or one integrated device.

Although it is assumed that the phone-module 110 and the multimedia module 120 are physically separated from each other, all or a portion of components of both the phone-module 110 and the multimedia module 120 may be constructed in one chip. For example, a unit for processing digital broadcasting data and a unit for processing data received through the mobile communication network may be constructed in one chip. Particularly, in mobile communication employing a code division multiple access (CDMA) scheme and DMB employing a code division multiplex (CDM) scheme, the units may be constructed in one chip. However, it should be noted that, within one chip, a unit for receiving and processing data through a mobile communication network corresponds to the phone-module and a unit for receiving and processing DMB data corresponds to the multimedia module.

The mobile communication terminal 100 concurrently performs a communication function and a multimedia function when a communication request is received in the course of performing the multimedia function. To this end, it is preferred that the mobile communication terminal 100 has a communication function mode for performing a communication function, a multimedia mode required for performing a multimedia function, and a concurrent service mode for concurrently performing both the communication function and the multimedia function.

In a typical hybrid terminal, operation mode transition is achieved by transferring a control authority (e.g., voice input/output control, multimedia data input/output control, etc.) used for controlling the operation of the corresponding terminal. In other words, the control authority is transferred to each control unit controlling each function realized in the hybrid terminal, thereby performing the corresponding function. Therefore, according to the present invention, a procedure of transferring a desired control authority between the main controller (MSM) 111 and the sub-controller 121 is performed in the multimedia mode, the communication mode, or the concurrent service mode. Herein, the main controller 111 and the sub-controller 112 may be constructed either as separate devices or one integrated device.

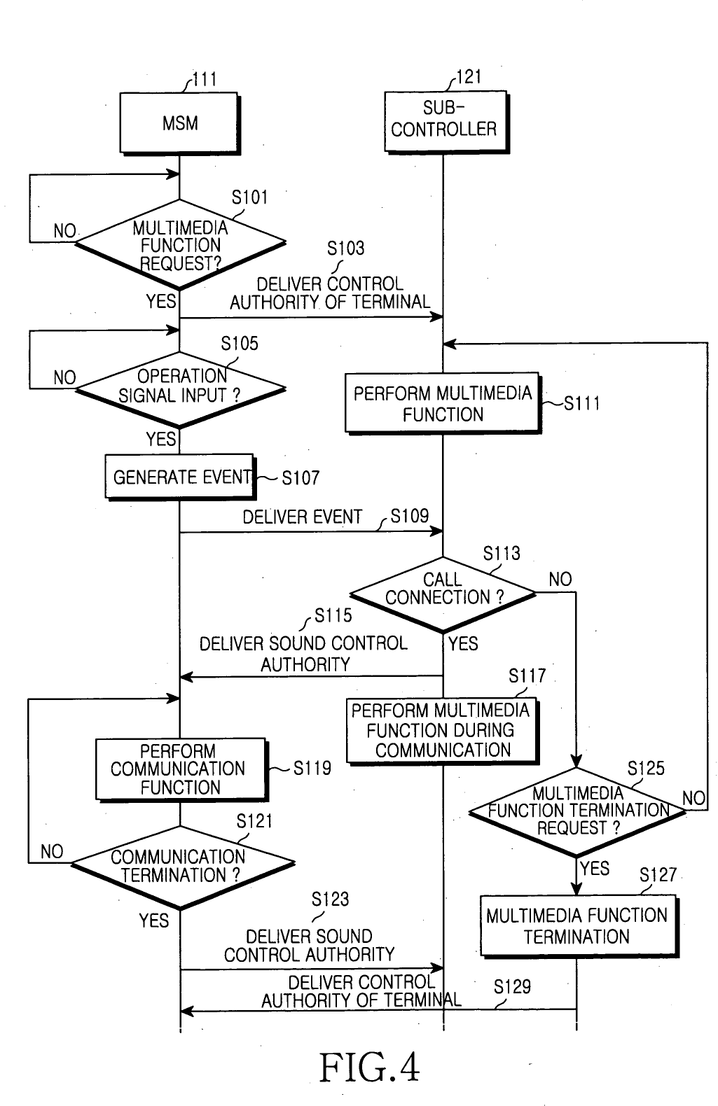

FIG. 4 is a flowchart illustrating a procedure for transferring a control authority for performing a communication function in the course of performing a multimedia function in the apparatus having a communication function and a multimedia function according to an embodiment of the present invention. In other words, FIG. 4 illustrates a procedure for transferring a control authority when the mobile communication terminal 100 shown in FIG. 3 operates in the multimedia mode, the communication mode, or the multimedia mode in communication. Hereinafter, the procedure of transferring a control authority over the mobile communication terminal 100 according to an embodiment of the present invention will be described with reference to FIGS. 3 and 4.

Generally, control authority over the mobile communication terminal usually belongs to the main controller (MSM) 111. Accordingly, when a multimedia function is requested (step S101), the main controller (MSM) 111 delivers the control authority to the sub-controller 121 for controlling a multimedia function (step S103). In this case, the main controller (MSM) 111 does not perform any functions for controlling the operation of the terminal except for generating an event corresponding to an operation signal input through a user interface and delivering the event to the multimedia sub-controller 121.

Accordingly, after step S103, the main controller (MSM) 111 detects the input of an operation signal step (S105) and generates the event corresponding to the operation signal (step S107) so as to deliver the event to the sub-controller 121 (step S109). For example, if the operation signal of a user is input through the key pad 114, the main controller (MSM) 111 performs only an operation of generating an event corresponding to the operation signal and delivering the event to the sub-controller 121.

In the meantime, if the sub-controller 121 receives the event through step S109 while performing multimedia functions by using the control authority delivered through step S103, the sub-controller 121 performs an operation corresponding to the event.

For example, if an event for call connection is received through step S109 (step S113), the sub-controller 121 transfers a control authority for voice control (e.g., voice input/output control) to the main controller (MSM) 111 (step S115) and then performs the multimedia functions during communication (step S117). In other words, the sub-controller 121 performs the multimedia functions excluding a voice output function. For example, if the request of a call connection is received while the sub-controller 121 is controlling digital broadcasting services, the sub-controller 121 continuously outputs video data included in digital broadcasting data through the second LCD 123 and stops the output of audio data by blocking the second speaker 124. In this case, it should be noted that it is possible to convert the audio data to be output through additional output interfaces (not shown) such as a head phone.

If an event for terminating the multimedia functions is received through step S109 (step S125), the sub-controller 121 terminates the multimedia functions (step S127) and then delivers the control authority to the main controller (MSM) 111 (step S129).

If the event delivered through step S109 is neither an event for call connection nor an event for terminating a multimedia function, the sub-controller 121 continuously performs the multimedia function (step S111).

The main controller (MSM) 111 having received a sound control authority in step S115 performs a communication function by using the sound control authority (step S119). In other words, the main controller 111 controls the microphone 113 and the first speaker 115 using the sound control authority, thereby performing the communication function including the transmit/receive of phone sound. After that, if the communication function is terminated (step S121), the main controller 111 returns the sound control authority to the sub-controller 121 (step S123). In this case, the control authority of the main controller (MSM) 111 for the microphone 113 and the first speaker 115 is extinguished.

Then, the sub-controller 121 which has been performing the multimedia function during communication returns to the multimedia mode using the sound control authority (not shown). For example, if the sub-controller 121 is processing a digital broadcasting service as the multimedia function during communication, the sub-controller 121 which has been outputting only video data using the second LCD 123 controls the second speaker 124 using the sound control authority received through step S123, thereby outputting audio data with the video data. At this time, if the sub-controller 121 is converting the audio data to be output through an additional output interface such as a head phone, the sub-controller 121 may output the corresponding data to the second speaker 124. In other words, the sub-controller 121 returns to the multimedia mode for outputting audio data with video data.

When the mobile communication terminal 100 receives a communication request signal in the course of performing a multimedia function, and when a user selects a communication mode (herein, it is preferred that the user employs a predetermined key used for switching into the concurrent service mode), the main controller (MSM) 111 generates an event for notifying this in step S107. In other words, the main controller (MSM) 111 generates an event for notifying the fact that an operation mode of the mobile communication terminal 100 should be switched into the communication mode (step S107) and then transfers the event to the sub-controller 121 (step S109). Meanwhile, if the sound control authority is received from the sub-controller 121 in response to the event (step S115), the main controller (MSM) 111 performs a communication function using the sound control authority (step S119). If the communication is terminated (step S121), the main controller 121 delivers the sound control authority to the sub-controller 121 (step S123).

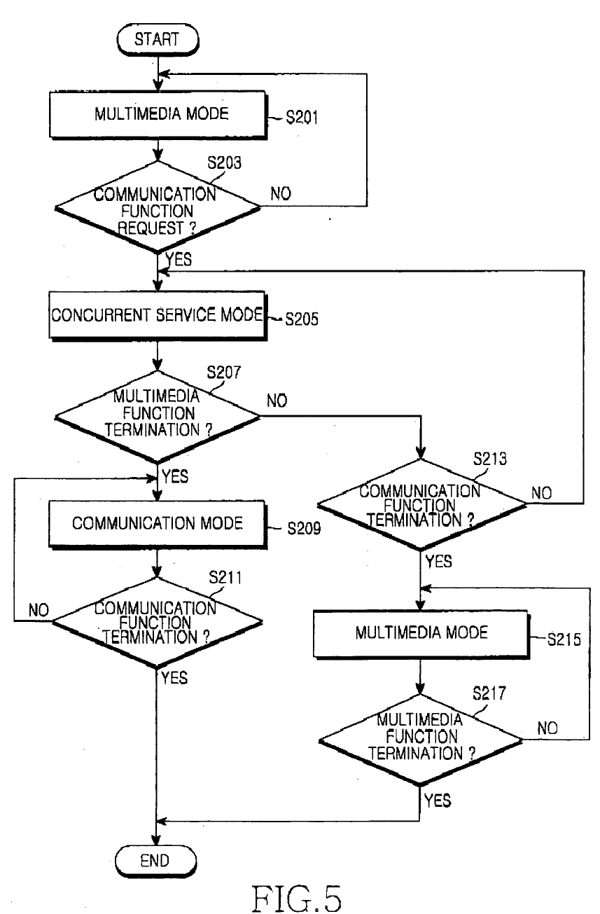

FIG. 5 is a flowchart illustrating a procedure of performing a communication function in the course of performing a multimedia function in the apparatus having a communication function and a multimedia function according to an embodiment of the present invention. In other words, FIG. 5 illustrates a procedure for changing the operation mode of the mobile communication terminal 100 shown in FIG. 3.

Referring to FIGS. 3 and 5, if a communication function is requested (step S203) while the mobile communication terminal 100 is operating in a multimedia mode (step S201), the mobile communication terminal 100 performs the concurrent service mode (step S205). In other words, the sub-controller 121 delivers only a sound control authority from among operation control authorities over the mobile communication terminal 100 to the main controller (MSM) 111 and retains remaining control authorities, thereby performing voice communication through the phone module 110 and performing multimedia functions excluding an audio output function through the multimedia module 120. The main controller (MSM) 111 controls the microphone 113 and the first speaker 115 using the sound control authority having been delivered from the sub-controller 121 so as to control input/output of phone sound. The sub-controller 121 blocks the second speaker 124 due to the extinction of the sound control authority and performs the multimedia function using only the second LCD 123.

If the multimedia functions are terminated under the concurrent service mode (step S207), the mobile communication terminal 100 performs the communication mode (step S209). In other words, the sub-controller 121 delivers the control authority over the mobile communication terminal 100 to the main controller (MSM) 111 and then enters into a waiting mode. The main controller (MSM) 111 maintains the communication mode (step S209) until the communication is terminated (step S211).

If the communication functions are terminated (step S213) under the concurrent service mode (step S207), the mobile communication terminal 100 terminates the concurrent service mode and enters into the multimedia mode (step S215). That is, the sub-controller 121 retrieves the sound control authority so as to control the second LCD 123 with the second speaker 124. In addition, if the multimedia function is terminated (step S217), the sub-controller 121 returns the control authority over the mobile communication terminal 100 to the main controller 111.

In FIG. 5, it is preferred that a predetermined key is established to notify the request for switching into each operation mode and the termination of a currently-processed operation mode in the mobile communication terminal 100. For example, it is preferred that a ‘communication key’ is set as a key for notifying that a communication function is requested under a multimedia mode, and a ‘termination key’ is set as a key for notifying that a communication function or a multimedia function is terminated under the concurrent service mode. In particular, it is preferred that, when the termination key is selected under the concurrent service mode, a guide message is displayed in such a manner that the user can know whether the termination key indicates the termination of a communication function or the termination of a multimedia function.

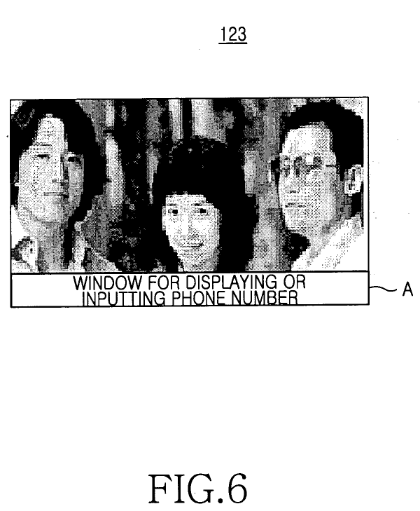

FIG. 6 illustrates a window for displaying or inputting a phone number under the concurrent service mode by way of example according to an embodiment of the present invention.

In other words, certain contents (e.g., a phone number to be input and a phone number of an originator to be displayed) which must be displayed in the execution of the communication function are displayed on the second LCD 123 controlled by the multimedia module 120. For example, when the mobile communication terminal 100 detects a request for call origination by a user under the multimedia mode for receiving digital broadcasting, the sub-controller 121 displays an origination phone-number using a predetermined area A of the second LCD 123 that is outputting digital broadcasting data. Herein, it is preferred that the predetermined area A is determined within the range set to avoid the disturbance of the display of the digital broadcasting data. For example, it is preferred that a phone-number to be originated through an OSD (on screen display) scheme is displayed on the lower end part of the second LCD 123.

As described above, according to an embodiment of the present invention, when a user tries to originate a call while using a multimedia function of a hybrid terminal (e.g., a terminal having a multimedia function and a communication function), the communication function can be performed without interrupting the multimedia function, so that user convenience for the usage of the hybrid terminal can be enhanced. For example, when the hybrid terminal receives an urgent call while performing the multimedia function, it is unnecessary to stop the multimedia function to receive the call, so that the user can conveniently perform the multimedia function and the communication function at the same time.

For example, in a concurrent service mode, a multimedia screen can be output on a display unit according to a key input without stopping the operation of a multimedia function while the multimedia function is performed.

In particular, a predetermined key (e.g., a communication key or a termination key) used for operation mode transition between a multimedia mode and a communication mode is used, so that the user can conveniently perform the mode transition. Video data necessary for the multimedia function and letter data necessary for the communication function are displayed through one display unit, and a specific area is established to avoid the disturbance of the video data by the letter data, so that user convenience for the hybrid terminal can be enhanced.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

1. An apparatus for performing a communication function and a multimedia function, the apparatus including a speaker unit, a microphone unit, a key input unit, and a display unit, the apparatus comprising:
a first control unit for controlling the communication function of the apparatus while in possession of control authority over the apparatus; and
a second control unit for controlling the multimedia function of the apparatus by receiving the control authority over the apparatus from the first control unit when the multimedia function is performed,
wherein, in a concurrent service mode where both the communication function and the multimedia function are concurrently performed when the communication function is requested while performing the multimedia function, the second control unit delivers a sound control authority over the apparatus to the first control unit, and the first control unit receives the sound control authority so as to control the microphone unit and the speaker unit.

2. The apparatus as claimed in claim 1, wherein the first control unit returns the sound control authority to the second control unit and allows the second control unit to resume controlling multimedia audio data when communication is terminated.

3. The apparatus as claimed in claim 1, wherein the first control unit and the second control unit recognize by press of a first preset specific key from among keys on the key input unit that the communication function is requested while performing the multimedia function.

4. The apparatus as claimed in claim 3, wherein the first preset specific key is a key for communication.

5. The apparatus as claimed in claim 1, wherein the first control unit and the second control unit recognize by press of a preset specific key from among keys on the key input unit that one of the communication function and the multimedia function is terminated during simultaneous execution of the communication function and the multimedia function.

6. The apparatus as claimed in claim 5, wherein the preset specific key is a key for communication termination.

7. The apparatus as claimed in claim 1, wherein the second control unit outputs multimedia video data on the display unit together with display contents relating to communication in the concurrent service mode.

8. The apparatus as claimed in claim 7, wherein the second control unit displays the display contents relating to communication on a portion of the display unit through an on screen display (OSD) scheme.

9. The apparatus as claimed in claim 1, wherein the first control unit and the second control unit are realized in one chip.

10. The apparatus as claimed in claim 1, wherein the apparatus is a mobile communication terminal having a camera.

11. The apparatus as claimed in claim 1, wherein the apparatus is a mobile communication terminal enabling video communication.

12. The apparatus as claimed in claim 1, wherein the apparatus is a mobile communication terminal capable of processing multimedia data.

13. The apparatus as claimed in claim 1, wherein the apparatus is a mobile communication terminal capable of receiving digital broadcasting.

14. The apparatus as claimed in claim 1, wherein the multimedia function includes a function of receiving and displaying digital multimedia broadcasting.

15. The apparatus as claimed in claim 1, wherein in the concurrent service mode, a multimedia screen can be output on the display unit according to a key input without stopping the operation of the multimedia function.

16. A method for performing a communication function while performing a multimedia function by an apparatus including a first control unit and a second control unit, the first control unit controlling the communication function of the apparatus while having control authority over the apparatus, the second control unit controlling the multimedia function of the apparatus by receiving the control authority over the apparatus from the first control unit when the multimedia function is performed, the method comprising the steps of:
delivering by the second control unit only a sound control authority over the apparatus to the first control unit when the communication function is requested while performing the multimedia function of the apparatus;
controlling by the first control unit transmit/receive of phone sound using the sound control authority to concurrently perform the communication function and the multimedia function;
delivering by the first control unit the sound control authority to the second control unit when the communication function is terminated; and
re-obtaining by the second control unit the sound control authority.

17. The method as claimed in claim 16, further comprising the step of displaying contents relating to communication and multimedia audio data on one display unit when the apparatus concurrently performs both the multimedia function and the communication function.

18. The method as claimed in claim 17, wherein, in the step of displaying contents relating to communication and multimedia audio data, contents relating to communication are displayed on a portion of the display unit through an on screen display (OSD) scheme.

19. The method as claimed in claim 16, wherein, in the step of delivering by the second control unit only the sound control authority, recognizing by press of a first preset specific key from among keys on a key input unit of the apparatus that the communication function is requested while performing the multimedia function.

20. The method as claimed in claim 19, wherein the first preset specific key is a key for communication.

21. The method as claimed in claim 16, wherein, in the step of delivering by the first control unit the sound control authority, recognizing by press of a preset specific key from among keys on a key input unit of the apparatus that one of the communication function and the multimedia function is terminated during simultaneous execution of the communication function and the multimedia function.

22. The method as claimed in claim 21, wherein the preset specific key is a key for communication termination.

23. The method as claimed in claim 16, wherein the multimedia function includes a function of receiving and displaying digital multimedia broadcasting.

24. The method as claimed in claim 16, wherein in a concurrent service mode, a multimedia screen can be output on a display unit according to a key input without stopping the operation of the multimedia function.
